(19) United States
(12) Patent Application Publication
(10) Pub. No.: US 2016/0264268 A1
(43) Pub. Date: Sep. 15, 2016

(54) Systematic tracking, harvesting and in-space disposal of space debris

(71) Applicant: John Aylmer, Winter Park, FL (US)

(72) Inventor: John Aylmer, Winter Park, FL (US)

(21) Appl. No.: 15/049,308

(22) Filed: Feb. 22, 2016

Related U.S. Application Data
(60) Provisional application No. 62/176,512, filed on Feb. 20, 2015.

(51) Int. Cl. B64G 4/00; B64G 7/00; B23K 26/70; B64G 1/24; B23K 26/402; B64G 99/00; G21F 5/14

(52) U.S. Cl. CPC B64G 4/00; B64G 9/00; B64G 7/00; G21F 5/14; B64G 1/242; B23K 26/402; B23K 26/70; B64G 2004/005

(57) ABSTRACT

The embodiments of invention relates to the in-orbit clearance and disposal of space debris within approved geospatial orbital regions using a wide assortment of apparatus and devices encompassing trawler harvesting, lasers cannons and remote piloted handling methods. All events are guided and managed by integrated United States Air Force (USAF) geospatial software and database systems to locate, legally verify, and then remove and transport collected space debris to a disposal facility in high geostationary earth orbit (GEO). These clearing methods and apparatus are coordinated and orchestrated in real-time event according to USAF procedures and policies and the Field Operations Commander.

### CROSS REFERENCE TO RELATED APPLICATIONS

This application claims are divisional and benefits of U.S. Non-Provisional application Ser. No. 15/047,316 filed on 7 Mar. 2016 and which is hereby incorporated by reference in its entirety; U.S. Non-Provisional application Ser. No. 15/055,606 filed on 28 Feb. 2016 and which is hereby incorporated by reference in its entirety; U.S. Non-Provisional application Ser. No. 15/048,670 filed on 19 Feb. 2016 and which is hereby incorporated by reference in its entirety.

### BACKGROUND OF THE INVENTION

“There is no easy or cheap solution to permanently clear space debris. Cleaning it up will be very expensive and take many years [decades]” (re: The Aerospace Corporation Website). At Table 3, several patents are presented highlighting many historic solutions to resolve this ever growing problem of space debris. Within each earlier solution, the patent describes only a singular event of deflecting/de-orbiting or vaporizing the debris both methods appearing not to be continuous or sustainable. With each of these invention solutions, two critical areas have been omitted the legal aspects of international and sovereignty rights and coordination and approval from the USAF who is tracking this debris for NASA and sovereign countries.

This present invention is to improve on the said prior patents at Table 3 through the development and fielding of an orbital infrastructure at FIGS. 1, 2. This infrastructure will manage a fleet of clearance apparatus and an orbital disposal facility 1. This space debris infrastructure development is only made possible through the fielding of a fleet of trans-orbital freight carriers 2 [non-provisional patent application Ser. No. 15/047,316]. This carrier provides a continuous logistics pipeline delivering up to 60 tons of cargo or drones to the working areas.

With the said orbital infrastructure description, the methods of this present invention requires for a systematic streamlining procedures to smoothly integrate the multi-level dynamics encountered by engineering, management, military, legal and political joisting prior to clearance and disposal of any space debris. In developing these systematic procedures, this current invention requires the understanding of the historical background of the debris itself and concerns of the military efforts underway and politics.

Using a 1991 data baseline as reference, Table 1 exhibits an assessment about the various debris dimensions and traceability. For example, improperly removing debris 4-inches and over from a heavier derelict rocket or structural component will break apart creating more debris and even more difficult to clear. 1991 apparatus is not suited for this task. Using this apparatus, a large population debris below 10-cm is very hard to find and track having the potential to damage a satellite or space station. Using 1991 apparatus and technology, Table 1 assessments reflect that it would be impossible to remove debris and it will remain in place or self de-orbit.

[Insert Table 1]

[symbol]

During the 90's, The Inter-Agency Space Debris Coordination Committee (IADC) had created an international governmental forum for the worldwide coordination of activities related to the issues of man-made and natural debris in space. It was comprised of steering group and four specified working groups covering measurements (WG1), environment and database (WG2), protection (WG3) and mitigation (WG4). There are international guidelines for doing this from the Inter-Agency Space Debris Coordination Committee (IADC). Many nations, including the United States, have rules about getting rid of old satellites and rockets. Therefore, the IADC guidelines remain difficult and expensive to eliminate old spacecraft, especially if the satellite or rocket was not designed for disposal. A safe conclusion today is the Table 1 and Table 2 objects remain where they are and the Committee truly does not have either the resolve, advanced apparatus or funding to aggressively elimination the threat. However, the working group's efforts might serve as baseline references for other US Government Tracking Efforts,

[Insert Table 2]

[symbol]

When examining Table 1 and Table 2, these tables introduces a vast and growing concern of space debris population and the IADC committees are essentially at a loss reducing the population. Table 3 tabularizes the suggested clearance methods which fundamentally unchanged since 1990. Although these patents and US NPGS thesis are well thought out methods, the singularity cost of implementing these patents to clear or significantly reduce this population where economic funding from IADC could never be realized. Notwithstanding, outlined in Table 4 provides an overview of the precise tracking methods of the debris population that remains a critical task and needed by this invention to fulfill it missions.

[Insert Table 3]

[symbol]

At Tables 1 and 2, an overview of the space debris population is exhibited showing the percentage breakdown and growing vastness of this debris population. To reduce this population, a synopsis of patents, Table 3 depicts an assortment of methods and viable within their singularity that are lacking to two (2) key said elements of tracking and legal attributes.

Table 4 provides an overview of the precise tracking and cataloguing methods by currently in use by the USAF, DoD and their support contractors. It is essential that this present invention needs to be integrated with tracking methods and legal and political environment to accomplish its collect and disposal methods.

With the said Table 4 tracking methods, FIG. 1 exhibits a management selection process to determine a conceptual operational environment (COE) of an area to be cleared guided by a programmatic tasks directing activities to define, approve and request execution of a project to clear debris within a specific geospatial orbital region (e.g. sandbox). With a specific orbital region authorized for clearance, FIG.2 presents a COE set-up of an orbital infrastructure to collect/harvest/vaporize, transport, and dispose of this debris field. However, this harvesting infrastructure will begin with few assets and be expanded over time. When at the appropriate time, these assets can be repurposed for other missions.

[Insert Table 4]

[symbol]

With the said Table 4 USAF tracking methods established, the legal and International Space Laws concerns are to be equally addressed in Table 5 which requires a smooth integration into the methods of this invention to ensure that debris is legally cleared and disposed of without violating nation sovereignty.

As this current invention is implemented, area of improvement comes with a closer coordination of the said Table 4 to the Legal and Treaty environment highlighted at Table 5. The coordination is needed because the debris is actually being permanently cleared. Being cleared, all appropriate databases must reflect the debris has been removed and no longer a liability.

As a new clearance project commences, ultimate harvest users would set-up location FIGS. 1, 2, 3 of the legal clearance areas and then invoke existing procedures for handling and disposal of large structural components, satellites and radioactive components. Identified radioactive components would adhere to international treaties agreements and placed in Space Barges and moved into safe Dump Orbit. This invention requires a one-time solution to understand and streamline working agreements to avoid future roadblocks and legal interventions to slow down clearance of debris. This is critical factor because the ‘Kessler Effect’, as stated by NASA scientist Donald Kessler in 1978, “remains a risk that will render space activities unfeasible for several decades”.

[Insert Table 5]

[symbol]

Table 5 highlights the complexity and perplexity of dealing with international treaties that coupled with the US legal atmosphere becomes an inherent functional part of this invention to ‘operate under’ and ‘integrated with’ any clearance and disposal effort. Methods and apparatus improvements exhibited in FIG. 1 thru FIG. 4 and being introduced with this patent anticipates that the future events could invoke ‘looking at’ and then streamlining to a singularity set of legal approval procedures and treaties to reduce the legal and political road blocks.

### DRAWINGS (5)

The artwork displayed shows all embodiments of the invention that show the fusion of:

FIG. 1: a pictorial overview of a program manager identifying a clearance of a specific geospatial region following the logic task flow process states to initiate a new project;

FIG. 2: a pictorial overview of a geospatial regional harvesting operation and a setup of several local clearance operations following a harvesting processing flow process;

FIG. 3: a pictorial overview of local clearance operations, apparatus and harvesting process flow tasks;

FIG. 4: an isometric view of an orbital foundry complex and disposal processing at a disposal of space debris;

FIG. 5: an isometric view of a trans-orbital freight carrier and an intra-orbital and planetary Space Barge.

### DETAILED DESCRIPTION OF THE INVENTION

In previous patents, methods of space debris disposal were a singular event and described one time usage of the apparatus for that event. These previous patents overlooked the complex integration into Department of Defense (DoD) environment highlighted in Table 4; legal liabilities of removal shown in Table 5; and the international treaty guidelines presented in Table 5A. Tables 4, 5 and 5A are implemented under the embodiments of these present inventions.

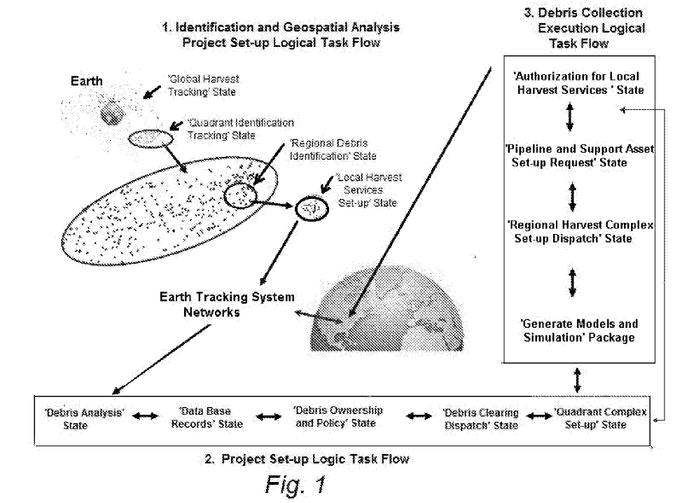

In the first embodiment of this invention, FIG. 1 depicts three program-level tasking states of: (1.) initiating the debris identification and geospatial analysis determining a specific area required to be cleared; (2) Set-up of a project performing data base analysis to determine debris ownership and dispatch messages to debris owners and dispatch recommended equipment list to appropriate commands; and (3) begin the execution project-level phase of generating a simulation and training package of the geospatial area to be cleared, request all harvesting assets to the clearance area, and acquire final disposition of the logistics pipeline assets to begin harvesting.

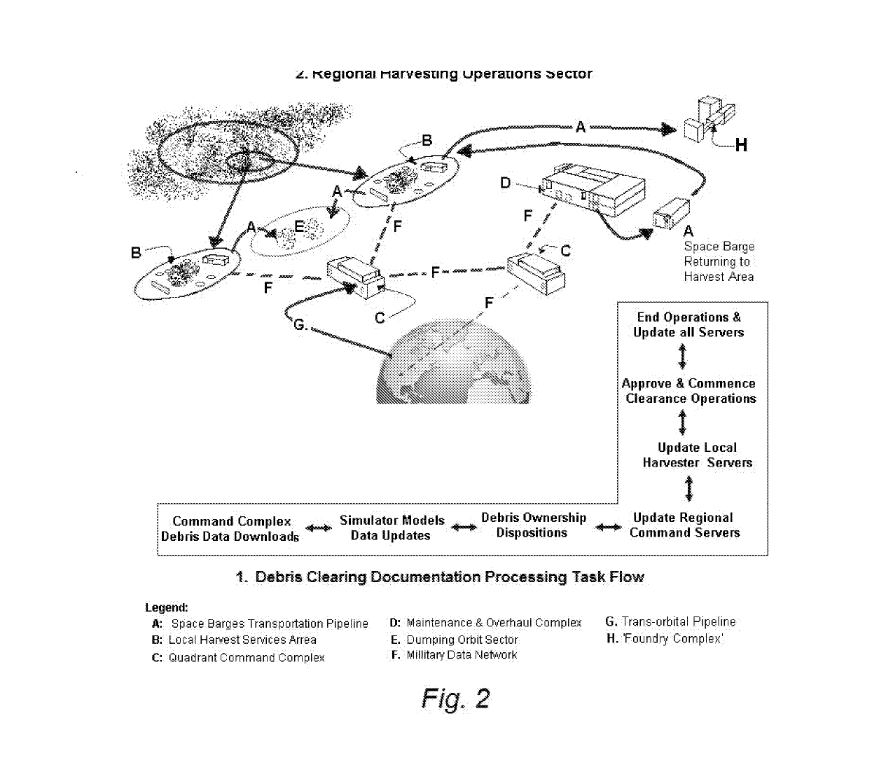

Second embodiment of this invention, FIG. 2 depicts two project-level tasking states of (1.) refining debris identification by interfacing to the appropriate data bases; updating the various models in the simulation and training package for testing real-time geospatial data prior to training; and issue orders to commence the collection operations; and upon receipt of orders; (2.) is the placement of the harvesting equipments assets in the appropriate operational area. Although FIG. 2 depicts a mature operational area, the said equipment and facility assets of this present invention will evolve and expand over time with fielding of a trans-orbital freight carrier 2.

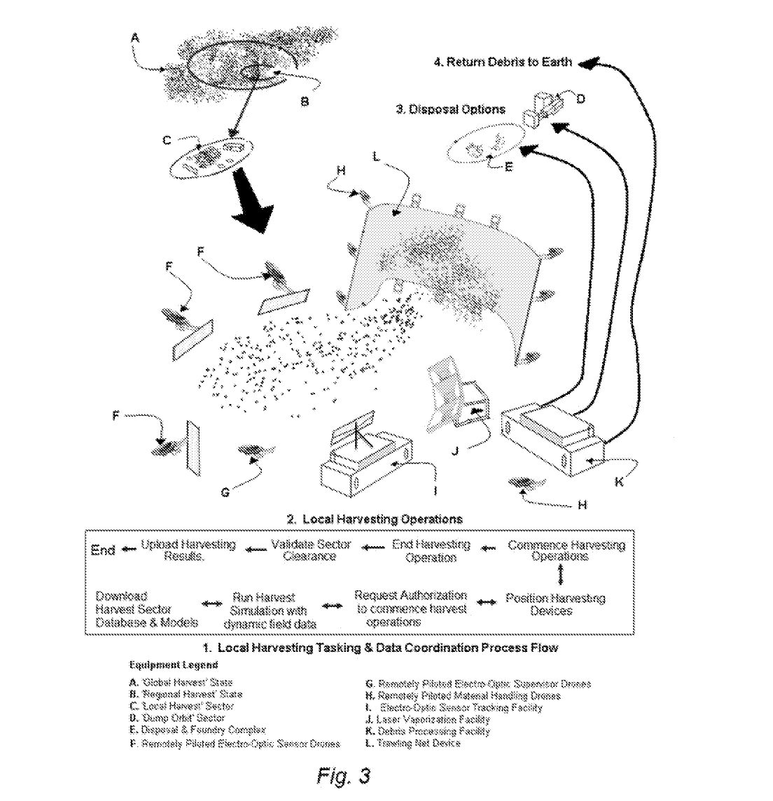

In the third embodiment of this invention is depicted at FIG. 3 is a conceptual harvesting operation. A debris field is dynamic and volatile where clearance methods are based on a specific debris field population, density of the debris population, and the direction and speed of the debris field. Based on debris field dynamics, the starting position of harvesting assets and the supporting assets is recommended and data downloaded into the simulators. With said debris field is information and dynamics defined for clearance. The following operational events will be set in motion:
Prior to commencing the harvesting operation, harvesting crews practice clearance operations using simulation training devices. These simulations provide an understanding of how each team will coordinate their actions in the collection, clearing, and disposable of this specific debris field.
During the actual harvesting and clearance operations, plurality clearance methods will be employed for removing large fragments or satellites using robotic space tugs. When determined feasible, laser cannons vaporize anything within a local sand box; netting operations for certain size debris; and location of any radioactive debris requiring specialized handling for later disposition.
Monitoring of a clearance operations are performed by a plurality of Electro Optic System (EOS) Guidance Drones. These Drones provide X, Y, and Z geospatial locations data of debris removed or cleared. This data is feed back to the USAF Situational Awareness tracking sites in Table 4. The USAF will notify the “Launching Country” that their debris and their liability removed.
Large debris fragments or satellites collected at a harvesting site are transferred to an awaiting Space Barge(s) and transferred to a disposition area for final classification. Upon classification, the material can be reclaimed by the launching country, eliminated, or when toxic or radioactive brought into the “Dumping Orbit”

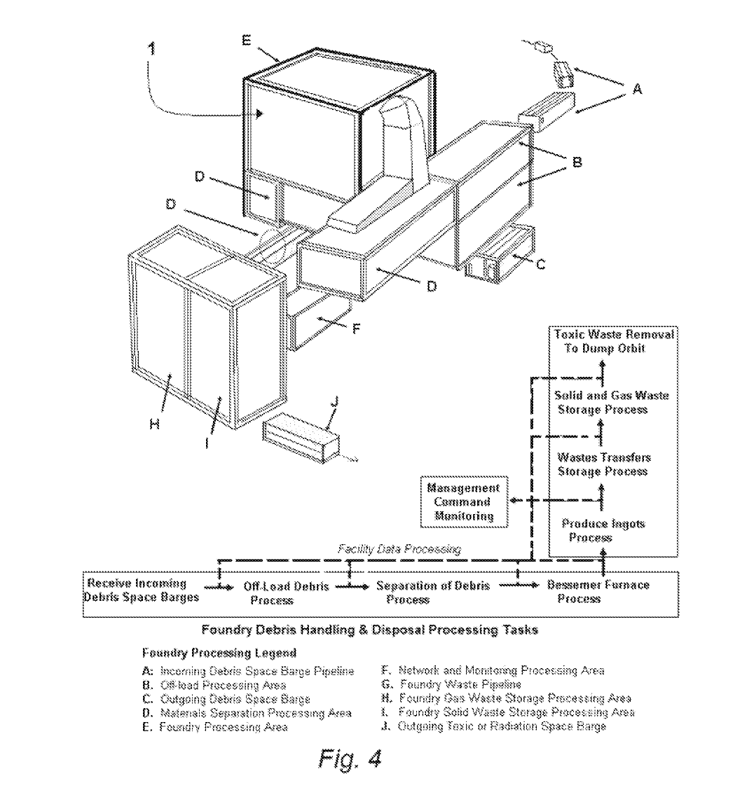

In the fourth embodiment of this invention is depicted at FIG. 4 [being] a conceptual Orbital Foundry Complex 1 that would serve as a debris classification, debris materials content separation; and smelting facility. When economically feasible, the “Foundry Complex” is placed into operation serving as the final solution to reclaim and separate all valuable metals for smelting. This complex is capable of supporting debris elimination and provides an orbital resource for mineral processing for any planetary and asteroid mining activities.

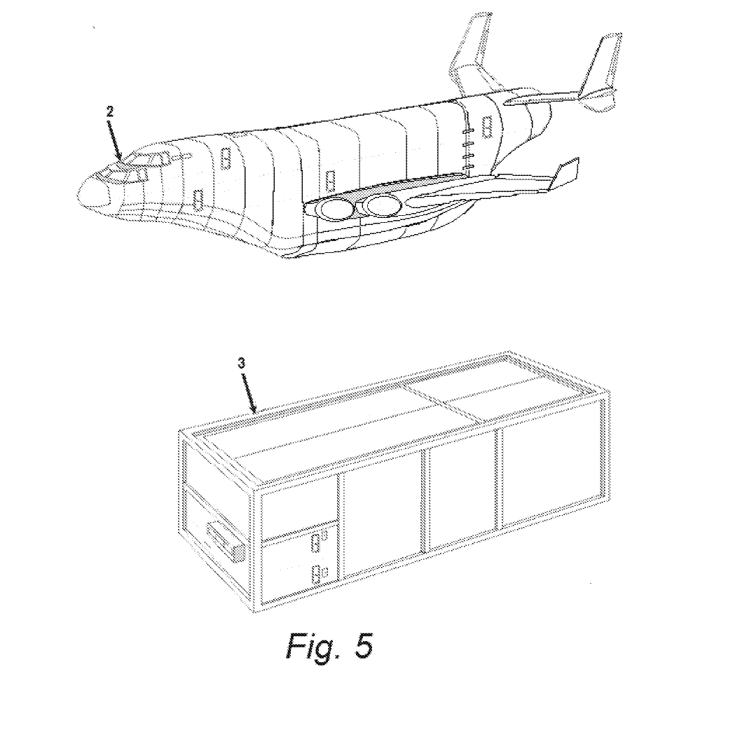

In the fifth embodiment of this invention, FIG. 5 displays the two critical apparatuses that make the present invention functional. The Trans-orbital freight carrier 2 [Non-Provisional Patent application Ser. No. 15,047,316] is solely responsible for the transport pipeline to bring all harvesting apparatuses and devices to the desired locations of said embodiments 3 and 4.

The first apparatus carrier 2 is the backbone for the trans-orbital transportation pipeline delivery and returning approximately 60 tons of materials and people to and from earth. The second apparatus is the Space Barge 3. The Barge(s) is the backbone for transportation pipeline services required for orbital and planetary sustainment and transportation of raw materials.

TABLE 1
Size and Impact Assessment

| Dimensional Size | Impact Assessment and Traceability |
|---|---|
| 10-cm or larger | Tracked and cataloged by Space Surveillance Network |
| | Catastrophic damage |
| 5 cm to 10 cm | Lower Limit tracking by Space Surveillance Network |
| | Catastrophic damage |
| 1 cm to 5 cm | Most cannot be tracked |
| | Major damage |
| 3 mm to 1 cm | Cannot be tracked |
| | Tests the upper limits of shielding if available |
| | Localized damages |
| 1 mm to 3 mm | Cannot be tracked |
| | Localized damages |

Source: Aerospace.Org/cords/

TABLE 2
2008 NASA Estimate Breakdown of Orbital Debris

| Percentage | |
|---|---|
| of Debris | Breakdown of Debris |
| 17% | Rocket Bodies |
| 19% | Mission-related debris |
| 22% | Non-functional spacecraft |
| 42% | Fragmentation debris |
| | Fuel, batteries, paint flakes |
| | 11,000+ objects greater than 4-inches (10-cm) |
| | 100,000+ between 0.4 to 4 inches (1-10-cm) |
| | 500,000+ estimated pieces of debris between 1 and 10 |
| | centimeters in size that cannot be seen |
| Radioactive | The number of objects is unknown and collection |
| Debris | requires special handling methods and placed into a safe |
| | Dump Orbit in a earth GEO or Moon LaGrange Orbit or |
| | determined by State Registry |

Source: NASA, 2008

TABLE 3
Basic Methods to Reduce Orbital Debris Population

| Patent Application | Basic Clearance | |
|---|---|---|
| or Number | Methods | Method Summarization |
| US Naval Post | Free electron | In this thesis paper, cover plurality of methods in which: |
| Graduate School | laser to | A high-peak power laser could be used to apply a small |
| Thesis | decelerate out of | change in orbital velocity over several orbits. By |
| ADA518696 | orbit with an | changing the orbital profile to lower the perigee and, |
| Dtd. March 2010 | alternate method | therefore, increasing atmospheric drag, the laser could |
| | to melt creating | greatly decrease the time it takes for debris to reenter. |
| | vaporization | High average power free electron laser (FEL) could melt |
| | | and then vaporize some of the debris material, resulting |
| | | in a smaller and less dangerous particle and making |
| | | near-Earth space safer for satellites and manned |
| | | missions |
| U.S. Pat. No. 8,919,702 B2 | Plume of using | Under, this invention modulate atmospheric gases to |
| Filed: Dec. 30, 2014 | atmospheric | clearing the space debris includes propelling a plume of |
| | gases | atmospheric gases substantially orthogonal to the path of |
| | | the debris and accelerate natural orbital decay to the |
| | | point of atmospheric re-entry. |
| U.S. Pat. No. 5,199,671 | Tether-induced | Matter is concentrated towards the center of a receiving |
| Filed: Apr. 6, 1993 | “gravity” by using | chamber surrounded by a polarity of magnetic forces |
| | electromagnetic | along a center line of a sleeve wall to be collected. |
| | devices | [Note: non-magnetic matter is not collected] |
| U.S. Pat. No. 5,153,407 | Radiation device | Under this invention, a radiation source for generating the |
| Filed: Oct. 6, 1992 | to bring on | radiation which brings about vaporization of the debris |
| | vaporization | material . . . moving in the orbit about earth |
| U.S. Pat. No. 5,028,211 | Tethering to | Under this invention, controlled and predictable fashion a |
| Filed: Jan. 1, 1992 | change the | first body is tethered to a lower altitude body. A suitable |
| | velocity and | length of tether is chosen to correlate with the orbital |
| | orbital altitude | characteristics of the higher altitude body such that the |
| | | lower altitude body has a relatively low velocity for its |
| | | orbital altitude |
| USP 2012/0286097 | Decelerating | Under this invention, metallic plate is located in front |
| A1 | space debris is | of a spacecraft in a traveling direction; space debris |
| Filed: Nov. 15, 2012 | dropped from a | flying toward the spacecraft is made to hit and |
| | geocentric orbit | penetrate this metallic plate; and thus the space debris |
| | | is crushed into small pieces |
| | | After the crush, space debris according to the may lead |
| | | to an unintended increase in the space debris due to a |
| | | failure to drop the space debris with the increased |
| | | orbiting velocity. |
| U.S. Pat. No. 5,405,108 A | Explosions to | The device is remotely detonated, and an impulse, |
| Filed: Apr. 11, 1995 | Change | caused by the expanding detonation products, is |
| | Trajectory | imparted to the debris, pushing the debris into a |
| | | reentry or earth escape trajectory. |

TABLE 4
Methods and DoD Programs for Tracking and Cataloguing Space Debris Objects

| SSA Program | Supplier | Description | |
|---|---|---|---|
| Space Fence | Lockheed Martin- | The upgraded Space Fence Program will have a modern, net- | |
| Program | led teamed with | centric architecture capable of detecting and effectively tracking | |
| Under the | General Dynamics, | much smaller objects in low/medium Earth orbit (LEO/MEO). It | |
| pending start of | AT&T and AMEC | was slated to go live by 2015, but subsequent developments and | |
| USA's Joint | | requirements changes have pushed it to December 2018 at the | |
| Space | | earliest. The core SPF capabilities are: | |
| Operations | | 1. | Detect, Track, and Identify. Discover, track, and |
| Center Mission | | | differentiate among space objects |
| System (JMS) | | 2. | Threat warning and Assessment. Predict and differentiate |
| Command | | | among potential or actual attacks, space weather |
| | | | environment effects, and space system anomalies |
| | | 3. | Intelligence characterization. Determine performance and |
| | | | characteristics of current and future foreign space and |
| | | | counterspace system capabilities, as well as foreign |
| | | | adversary intentions. |
| | | 4. | Data integration. Correlate and integrate multisource data |
| | | | into a single common operational picture and enable |
| | | | dynamic decision making. |

| | | |
|---|---|---|
| Space-Based | Boeing, Space and | All existing capabilities and functional requirements will be |
| Space | Intelligence | upgraded then intergraded into the new initial operational |
| Surveillance | Systems Division | capability of the 2017 Space Fence Program initial operational |
| (SBSS) | | capability. |
| Satellites | | Space Fence will be replaced the existing Air Force Space |
| | | Surveillance System, or VHF Fence, which has been in service |
| | | since the early 1960s. The new system's initial operational |
| | | capability is scheduled for 2017. |
| Joint Space | 614th Air and | Focal point for the operational employment of worldwide |
| Operations | Space Operations | joint space forces, and enable the commander of Joint |
| Center, or | Center, | Functional Component Command for Space to integrate space |
| (JspOC) | Vandenberg AFB | power into a global military operations. |
| | | Clearing house of military's tracking of space-based object |
| Australia's | Australia's Electro | The EOS Program uses a combination of radar-based |
| Electro Optic | Optic Systems Pty | systems, lasers and sensitive optical systems to detect, |
| Systems (EOS) | Ltd | track and characterize man-made debris objects. |
| Program | | Established by Lockheed to act as “a strong |
| | | complement the 2017 U.S. Air Force's Space Fence |
| Australia's | CRC Mt Stromlo, | The CRC charter will confront the threat of space debris |
| Cooperative | Australia | colliding with satellites in earth orbit and bring together |
| Research | | expertise and resources from leading universities, |
| Centre (CRC) | | space agencies and commercial research providers to |
| for Space | | develop research programs which will focus on: |
| Environment | | More accurate space debris tracking |
| Management | | Improve Predictions of Space Debris Orbits |
| | | Predict and monitor potential collisions in space |
| | | And other related projects and efforts |
| Commercial | Analytical Graphics, | The ComSpOC is now tracking 4,426 total space objects, |
| Space | Inc. | 75% of all active geosynchronous (GEO) satellites and |
| Operations | | 100% of all active GEO satellites over the continental |
| Center | | U.S. ComSpOC has deployed over 28 optical sensors |
| (ComSpOC) | | and one radar site. An RF data processing test has been |
| | | verified by ComSpOC's ability to do near real-time |
| | | maneuver characterization and continuous custody for |
| | | active GEOs. |
| Space Object | Lockheed, Santa | The SPOT Program is array of ground-based system |
| Tracking (SPOT) | Cruz, CA | consisting of three, 1-meter optical telescopes and sets |
| Program | | them on rails similar to train tracks to move the |
| | | telescopes around. |
| | | SPOT facility is employing a new software to manage a |
| | | software delay-line, fiber coupling of the telescopes, |
| | | and then the integrated into software for imagery |
| | | construction. |
| Australia's | Australia's Electro | The EOS Program uses a combination of radar- |
| Electro Optic | Optic Systems Pty | based systems, lasers and sensitive optical systems |
| Systems (EOS) | Ltd | to detect, track and characterize man-made debris |
| Program | | objects. Established by Lockheed to act as “a strong |
| | | complement the 2017 U.S. Air Force's Space Fence |
| Australia's | CRC Mt Stromlo, | The CRC charter will confront the threat of space |
| Cooperative | Australia | debris colliding with satellites in earth orbit and |
| Research | | bring together expertise and resources from |
| Centre (CRC) | | leading universities, space agencies and commercial |
| for Space | | research providers to develop research programs |
| Environment | | which will focus on: |
| Management | | More accurate space debris tracking |
| | | Improve Predictions of Space Debris Orbits |
| | | Predict and monitor potential collisions in |
| | | space |
| | | And other related projects and efforts |
| Commercial | Analytical Graphics, | The ComSpOC is now tracking 4,426 total space |
| Space | Inc. | objects, 75% of all active geosynchronous (GEO) |
| Operations | | satellites and 100% of all active GEO satellites over |
| Center | | the continental U.S. ComSpOC has deployed over |
| (ComSpOC) | | 28 optical sensors and one radar site. An RF data |
| | | processing test has been verified by ComSpOC |
| | | ability to do near real-time maneuver |
| | | characterization and continuous custody for active |
| | | GEOs. |
| Space Object | Lockheed, Santa | The SPOT Program is array of ground-based system consisting |
| Tracking (SPOT) | Cruz, CA | of three, 1-meter optical telescopes and sets them on rails |
| Program | | similar to train tracks to move the telescopes around. |
| | | SPOT facility is employing a new software to manage a |
| | | software delay-line, fiber coupling of the telescopes, and then |
| | | the integrated into software for imagery construction. |
| Secure World | Partnership | Agreement between the US, UK, Australia and Canada where |
| Foundation | between US, UK, | each country will have their own Operational Centers and |
| | Australia and | having coordination between them, “he said.” It's a signaling |
| | Canada | agreement among the four countries that this is important and |
| | | provides a political framework for moving forward. |
| Design and | Numerica Corp | USAF awarded 5 contracts in 2012 to Numerica Corp for new |
| development of | | algorithms to aid the USAF in safeguarding space assets and in |
| advanced | | maintaining space situational awareness (SSA) for current and |
| algorithms to | | future space deployments, through identification and tracking |
| augment its SS | | of orbiting objects. The algorithms will offer enhanced |
| awareness | | estimation and data fusion, multi-sensor space object tracking, |
| | | efficient propagators and gravity models, as well as |
| | | uncertainty management and anomaly detection for the SSA |
| | | mission. |
| Next- | USAF space | Under a Numerica Corp Contract, USAF currently maintains an |
| generation SSA | catalogue | inventory of over 20,000 detectable space objects orbiting the |
| system | Numerica Corp | Earth, which are expected to increase up to 200,000 within the |
| | | next five to ten years, due to improved sensors, future |
| | | collision events and continuous fragmentation. |

SOURCE: See Other References

TABLE 5
Legal Liability Issues over Debris Collection (Kessler Effect)

| | Affects The | | |
|---|---|---|---|
| | Methods of | | |
| Core Legal Issues | this Invention | Summary | |
| Issues regarding | Yes, each State | In general, challenging is establishing the “fault” of the | |
| filing a claim | must approve | launching State. The fault liability presumes that a standard of | |
| under the liability | and validate | care exists against which the reasonableness of the defendant's | |
| convention | removal and to | actions can be judged. Proving fault requires the claimant State | |
| | update their | to establish that the owner of the debris that caused the | |
| | registries | damage did not comply with national or international standards | |
| | | or guidelines for conducting space activities or for debris | |
| | | mitigation. | |
| Liability regime | | Article VII in the Liability Convention of 1972 sets up a liability | |
| for damage | | regime according to which “Launching States” are liable for | |
| caused by space debris | | damage caused by debris generated by any private entities for | |
| | | which such States are responsible. The liability regime is two- | |
| | | fold depending on where the damage occurred. | |
| | | (a) | If the damage is caused on the surface of the Earth or to |
| | | | aircraft in flight, the simple proof of causality of damage is |
| | | | sufficient, regardless of proving fault. |
| | | (b) | If the damage is caused to the space object of another |
| | | | State in outer space, the fault of the entity for whom the |
| | | | Launching State is responsible must be proven |
| State Parties | | Launching State is defined as: “A State which launches or | |
| Overview | | procures the launching of a space object”; or “A State from | |
| | | whose territory or facility a space object is launched.” | |
| Issues regarding | | Only Launch State's which are parties to this Liability | |
| filing a claim | | Convention can file a claim, For the defendant to be liable, | |
| under the liability | | claimant would have to: | |
| convention | | (a) | Prove that damage was caused to the defendant citizens |
| | | | or to space objects registered by defendant on the |
| | | | registry which it maintains; |
| | | (b) | Identify the space object that caused the damage and |
| | | | establish that who is “Launching State” defendant and |
| | | | therefore has ownership and control over it; and |
| | | (c) | Prove that the damage was caused by the fault (as the |
| | | | damage has occurred in outer space) of the defendant or |
| | | | the fault of a private entity for whom the defendant is |
| | | | responsible. |

While the first element (a) may be relatively easy to prove,
establishing the causality of damage caused by space debris
may be difficult, France is lucky - the shielding part is large
enough to be tracked and France can prove that it is from a UK
satellite. But it would be difficult to identify particulate debris
and trace it back to the owner of the original launched object.
Currently only voluntary, non-binding standards and guidelines

Overview of Space Law Treaties and Laws Protocols

| Treaties and | | |
|---|---|---|
| Protocols | Abstract | Summarization |
| United Nations | Office for | Outer Space Affairs implements the decisions of the General Assembly |
| Office for Outer | Outer Space | and of the Committee on the Peaceful Uses of Outer Space. The office |
| Space Affairs | Affairs | has the dual objective of supporting the intergovernmental discussions |
| within the | covering | in the Committee and its Scientific and Technical Subcommittee and |
| Department for | Space Laws | Legal Subcommittee, and of assisting developing countries in using space |
| Political Affairs | and other | technology for development. In addition, it follows legal, scientific and |
| UN Office | related | technical developments relating to space activities, technology and |
| Vienna | documents. | applications in order to provide technical information and advice to |
| | | Member States, international organizations and other United Nations |
| | | offices. |
| | | Sources http://www.unoosa.org/oosa/en/OOSA/index.html |
| | | http://www.unoosa.org/oosa/en/SpaceLaw/index.html |
| Inter-Agency | Baseline | International removal guidelines outlined by the IADC. Many nations, |
| Space Debris | Guidelines | including the United States, have rules about getting rid of old satellites |
| Coordination | | and rockets. Therefore, the IADC guidelines remain difficult and |
| Committee | | expensive to eliminate old spacecraft, especially if the satellite or rocket |
| (IADC). | | was not designed for disposal. |
| UK Outer Space | Magna Carta | UK Secretary of State maintains a register of space objects which have |
| Act 1986 | for UK Space | been licensed by the UK. Outlined in Table 5 and fairly universal |
| | Law | practices |
| Outer Space | Magna Carta | Interpretative difficulties of this Treaty are illustrated in the Article IX |
| Treaty of 1967. | of Space Law | which explains that the study and exploration of outer space shall be |
| | | conducted, “so as to avoid their harmful contamination,” and that States |
| | | Parties, “shall adopt appropriate measures for this purpose.” The Article |
| | | does not enlighten us as to what constitutes “harmful contamination'” |
| | | or what such “appropriate measures” consist of. Space debris is not |
| | | normally classed as “harmful contamination;” the phrase being usually |
| | | construed as biological or radioactive contamination. |
| | | An international consultation process is also provided for by Article IX. If |
| | | a State believes that an activity planned by it or its nationals would |
| | | “cause potentially harmful interference” to the activities of another |
| | | State, it shall undertake consultations before proceeding. A State Party |
| | | may also request consultations if it believes that an activity planned by |
| | | another State would cause it potentially harmful interference. But it is |
| | | difficult to describe the existence or creation of space debris as a future |
| | | “planned” activity. The provisions also do not address the issue of |
| | | current or completed activities or the problem of current space debris. |
| | | The Outer Space Treaty Article VIII of provides that each Launch State |
| | | retains ownership and control over objects launched into space that are |
| | | registered on its registry. |

The claims are as follows:

1. Dedicated stand-up Program Management structure within the Joint Space Operations Center (JSOC) having management of a in-situ continuous and enduring clearance and disposal operation, said initial operational capabilities comprising of:
Tracking and Surveillance software and databases from multiple sources are providing continuous two-way communications of real-time geospatial location data to the said harvesting apparatus and devices guiding each system to a debris object for clearance.
Modeling, Simulation and Training (M, S&T) provides an expansion of current JSOC modeling environment. The said harvesting apparatus and devices are remotely piloted unmanned robotic vehicles in permanent geosynchronous orbit and under the control by the JSOC team. With the said modeling, Simulation and Training is a perpetual requirement to ensure proper and safe clearance of debris and training in the use of these vehicles.
Protection is provided by the said harvesting apparatus and devices are remotely piloted unmanned robotic vehicles. As sensors and tracking determined that a specific large space debris or uncontrolled satellite is de-orbiting quickly the situational awareness warns of the potential hazards. Remotely piloted unmanned robotic vehicle devices are deployed to collect and return it to the said disposal area or to orbital foundry.
Mitigation of any space debris while in orbit has specific protocol, procedures, legal and international implications to follow prior to removal. With the said embodiments of this invention, the actual removal and total mitigation is embedded within the JSOC management software systems guiding remotely unmanned robotic vehicle(s) devices and other apparatus to collect and dispose of debris following appropriate protocol, or placed in a dump orbit.
Transportation Pipeline is established with a fleet of trans-orbital freight carriers to carry afloat and return with harvesting devices, sensors, personnel and specific debris cargo for the said embodiments of this invention.

2. Initiating the methods said in claim 1, wherein outlines the upper-level management, training and software requirements to be in place and tested prior to fielding the in-orbit support environment of said transportation pipeline, defining the region for a dump orbit, and establish procedures for managing the disposal area and sustainable resources.

3. The methods said in claim 2, wherein as the actual debris collection events begin to transmit the data to the harvesting apparatus providing identification, classification, and geospatial area coordinates and debris dynamics. With said data downloads, harvesting devices aggressively remove and bring the large debris inside space barges to the said disposal area and upon completion update the said tracking databases.

4. The method said in claim 3, wherein the said removal methods engage remotely piloted laser vaporization spacecraft devices to clear all identified materials capable of being safely vaporized.

5. The method said in claim 3, wherein the said removal methods engage remotely unmanned robotic vehicle(s) devices to collect and place toxic and nuclear wastes to specialized space barges and transported to the said dump orbit region.

6. The method said in claim 2, wherein the said removal methods engage, where feasible or practical, harvesting nets to collect identified debris or repurposed to validate this specific geospatial region has been cleared and safe.

7. The method said in claim 5, wherein the said disposal methods for satellites begins with a contained controlled orbital location to separate materials and determine final disposition or return to earth for repairs.

8. The method said in claim 7, wherein the said disposal methods are expanded to a Orbital Foundry Complex to better separate materials and determine final disposition for smelting or repair; provide a location for performing satellite repairs and upgrades returning them to full operational status.

9. The method said in claim 2, wherein the said transportation pipeline methods engage trans-orbital freight carrier devices providing total sustainment of all harvesting apparatus and operating environment.

10. The method said in claim 9, wherein all said devices, systems and apparatuses are capable of being repurposed for other orbital or planetary activities.
